(19) United States
(12) Patent Application Publication
(10) Pub. No.: US 2018/0253694 A1
(43) Pub. Date: Sep. 6, 2018

(54) GENERATING JOB RECOMMENDATIONS USING MEMBER PROFILE SIMILARITY

(71) Applicant: LinkedIn Corporation, Sunnyvale, CA (US)

(72) Inventors: Krishnaram Kenthapadi, Sunnyvale, CA (US); Yiqun Liu, Sunnyvale, CA (US); Bo Zhao, Redwood City, CA (US)

(21) Appl. No.: 15/451,154

(22) Filed: Mar. 6, 2017

(51) Int. Cl. G06Q 10/10; G06Q 50/00

(52) U.S. Cl. CPC G06Q 10/1053; G06Q 50/01

(57) ABSTRACT

An on-line social network system includes or is in communication with a recommendation system that is configured to leverage member profile similarity information for selecting one or more job postings for presentation to a member. The recommendation system accesses a profile of a subject member, engages the relevance model to select job postings for presentation to the subject member based on the respective relevance values generated for the job postings, and also selects one or more additional jobs to be presented to the member based on respective member profile similarity scores generated for these additional job postings.

### TECHNICAL FIELD

This application relates to the technical fields of software and/or hardware technology and, in one example embodiment, to system and method to generate job recommendations in an on-line social network system using member profile similarity scores.

### BACKGROUND

An on-line social network may be viewed as a platform to connect people and share information in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member. An on-line social network may store include one or more components for matching member profiles with those job postings that may be of interest to the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to generate job recommendations in an on-line social network system using member profile similarity scores may be implemented;

FIG. 2 is block diagram of a system to generate job recommendations in an on-line social network system using member profile similarity scores, in accordance with one example embodiment;

FIG. 3 is a flow chart illustrating a method to generate job recommendations in an on-line social network system using member profile similarity scores, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to generate job recommendations in an on-line social network system using member profile similarity scores is described. In the following description, for purposes of explanation, numerous specific details are set froth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in discourse. Thus, any type of server environment, including various system architectures, may employ various embodiments of the application-centric resources system and method described herein and is considered as being within a scope of the present invention.

For the purposes of this description the phrases “an on-line social networking application,” “an on-line social network system,” and “an on-line social network service” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may include or be associated with links that indicate the member's connection to other members of the social network. A member profile may also include or be associated with comments or recommendations from other members of the on-line social network, with links to other network resources, such as, e.g., publications, etc. The profile information of a social network member may include various information such as, e.g., the name of a member, current and previous geographic location of a member, current and previous employment information of a member, information related to education of a member, etc. The on-line social network system also maintains information about various companies, as well as so-called job postings. A job posting, also referred to as merely “job” for the purposes of this description, is an electronically stored entity that includes information that an employer may post with respect to a job opening.

The information in a job posting may include, e.g., industry, company, job position, required and/or desirable skills, geographic location of the job, etc. Member profiles and job postings are represented in the on-line social network system by feature vectors. The features in the feature vectors may represent, e.g., a job industry, a professional field, a job title, a company name, professional seniority, geographic location, etc.

The on-line social network system includes a recommendation system configured to select one or more job postings for presentation to a member based on criteria that indicates that a particular job posting is likely to be of interest to the member. The criteria that indicates that a particular job posting is likely to be of interest to the member, in one embodiment, is associated with a relevance value.

When a new login session is initiated for a member in the on-line social network system, the recommendation system generates respective relevance values for pairs comprising a member profile representing the member in the on-line social network system and a job posting. The relevance values are generated, in one embodiment, using a statistical model (referred to as the relevance model for the purposes of this description). A relevance value reflects the likelihood that a member represented by the member profile applies for a job represented by the job posting. Those job postings, for which their respective relevance values for a particular member profile are equal to or greater than a predetermined threshold value, are presented to that particular member, e.g., on the news feed page of the member or on some other page provided by the on-line social networking system.

The recommendation system is configured to determine that a job posting should be selected for presentation to a member as a recommended job even if it does not satisfy the criteria associated with the relevance value generated by the recommendation system with respect to that job posting. The recommendation system leverages member profile similarity information for selecting an additional job posting for presentation to a member, even when the relevance score calculated for the member's profile and the additional job posting is below a predetermined threshold value that indicates that the additional job posting should be presented to the member. In one embodiment, member profile similarity information is used to include into a list of recommended jobs specifically jobs that have their respective job poster values less than or equal to an underperformance threshold value, in order to enhance visibility of underperforming job postings. A job poster value (JPV) represents a value that is still owed to a job poster (e.g., to the company that posted the job with the on-line social network service) at a certain point in time. A job posting entity is typically charged a fee for submitting a job posting to the on-line social network system, which creates an expectation on the part of the job posting entity that the job posting would receive a certain amount of value for the fee that was charged. This value is a job poster value, and it may be affected by the level of interest in the job expressed by qualified members of the on-line social network system. The level of interest may be gauged by the number of applications received with respect to the job posting, the number of views and the number of impressions. A job posting that has received fewer applications and views after a certain period since it was posted with the on-line social network service may be described as having a higher job poster value. A job that has received a greater number of applications from qualified candidates and a greater number of views after a certain period since it was posted with the on-line social network service may be described as having a lower job poster value.

Returning to the scenario where the recommendation system leverages member profile similarity information for selecting an additional job posting, in one embodiment, when the recommendation system accesses a profile of a subject member in order to generate a set of job recommendations for the associated member, the recommendation system engages the relevance model to select job postings for presentation to the subject member based on the respective relevance values generated for the job postings, and also selects one or more additional jobs to be presented to the member based on respective member profile similarity scores generated for these additional job postings.

These additional jobs, for which the recommendation engine generates member profile similarity scores, are jobs that have been recommended to other members whose profiles in the on-line social network system are similar to the profile of the subject member. Similarity of two member profiles may be determined, e.g., by comparing feature vectors representing the two respective profiles. The member profile similarity score generated for a job posting with respect to a subject member profile may be derived based on the result of comparison of respective feature vectors of the subject member profile and a member profile that represents a further member, to whom the job posting has been recommended.

In some embodiments, the member profile similarity score for a pair comprising a subject member profile and a particular job posting is determined by applying a graph analysis algorithm to a member profile similarity graph. The member profile similarity graph is a tripartite graph. The first set of nodes in the member profile similarity graph comprises nodes representing member profiles in the on-line social network system. The second set of nodes comprises nodes representing those member profiles in the on-line social network system that are similar to at least one member profile represented by a node in the first set of nodes. The third set of nodes represents respective job postings recommended to at least one member represented by a member profile represented by a node from the second set of nodes. In one embodiment, the job postings selected to be represented by respective nodes in the member profile similarity are only those job postings that have their respective job poster values less than or equal to an underperformance threshold value. The discussion of a job poster value is provided further below.

An edge between a node from the first set of nodes and a node from the second set of nodes indicates that the member profile represented by the node in the second set of nodes has been identified as similar to the member profile represented by the node from the first set of nodes. Similarity of two member profiles may be expressed as a value derived based on the result of comparison of the feature vectors representing the two profiles. Two profiles may be identified as similar, e.g., for the purpose of constructing the member profile similarity graph, if the value representing similarity between the two profiles is equal to or greater than a predetermined threshold value. A weight assigned to an edge between a node from the first set of nodes and a node from the second set of nodes is calculated, e.g., as or based on the similarity score calculated for the two profiles represented by the respective nodes.

An edge between a node from the second set of nodes and a node from the third set of nodes indicates that the job represented by the node in the third set of nodes was previously recommended to the member represented by the node from the second set of nodes. A weight assigned to an edge between a node from the second set of nodes and a node from the third set of nodes is calculated as or based on the relevance score for a pair comprising a member profile and a job posting represented by the respective nodes.

Examples of a graph analysis algorithm that the recommendation system can use to generate a member profile similarity score using the tripartite graph described above are described further below.

For example, a member profile similarity score for an additional job posting with respect to a subject member profile may be calculated, using the member profile similarity graph described above, as probability of a random walk starting at a node (from the first set of nodes) representing the subject member profile and reaching the node representing the additional job posting (from the third set of nodes). In other words, what is being considered is a Markov chain with nodes representing underperforming job postings in the third set of nodes as the absorbing states. The absorbing states are ranked based on the probability of reaching that state from the node representing the subject member profile. Another example graph analysis algorithm that the recommendation system can use to generate a member profile similarity score is a decreasing function (such as reciprocal) of the graph commute time between a node (from the first set of nodes) representing the subject member profile and the node representing the additional job posting (from the third set of nodes). Yet another example graph analysis algorithm involves computing the number of length 2 paths from a node representing the subject member profile and the node representing the additional job posting. Any of these graph analysis algorithms can utilize edge weights for deriving the member profile similarity scores.

A member profile similarity graph is generated and stored in the on-line social network system. It is updated based on a pre-determined schedule and/or, e.g., as the status of one or more new job postings are identified as underperforming based on their respective JPVs or as one or more new job postings are no longer identified as underperforming based on their respective JPVs.

The recommendation system selects some of the job postings to be included in the set of job recommendations based on their respective relevance values, and some additional jobs (from those that have been identified as underperforming based on their respective JPVs) based on their respective member profile similarity scores. The recommendation system, in one embodiment, reserves a certain number of slots in the set of job recommendations specifically for additional underperforming jobs and fills these slots with job postings that have the highest member profile similarity values. In some embodiments, the recommendation system generates, for each candidate job posting, a combined score based on its respective relevance score and its member profile similarity score. The recommendation system then uses these combined scores to rank the candidate job postings and includes the top-ranking ones into the set of job recommendations. A combined score for a job posting j with respect to a member profile m can be generated as C(r(m,j), s(m,j)), where r(m,j) is the relevance score and s(m,j) is the member profile similarity score. C(,) could be a monotonically increasing function in two variables such as C(x,y) x(l+y); C(x,y)=x.exp(v), etc.

The member profile similarity values, in some embodiments, are used as features to learn coefficients for a machine learning algorithm such as, e.g., logistic regression, where the associated model is trained on a ground truth dataset of (member profile, underperforming job posting) tuples.

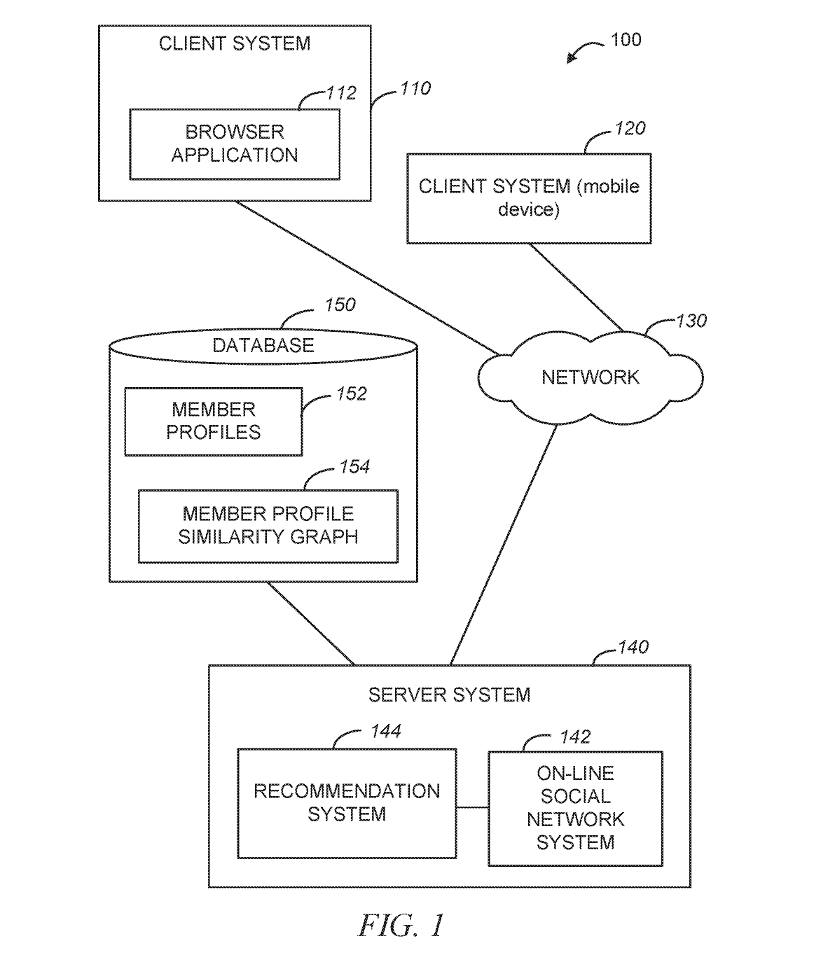

An example recommendation system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152. The database 152 may also store the member profile similarity graph 154.

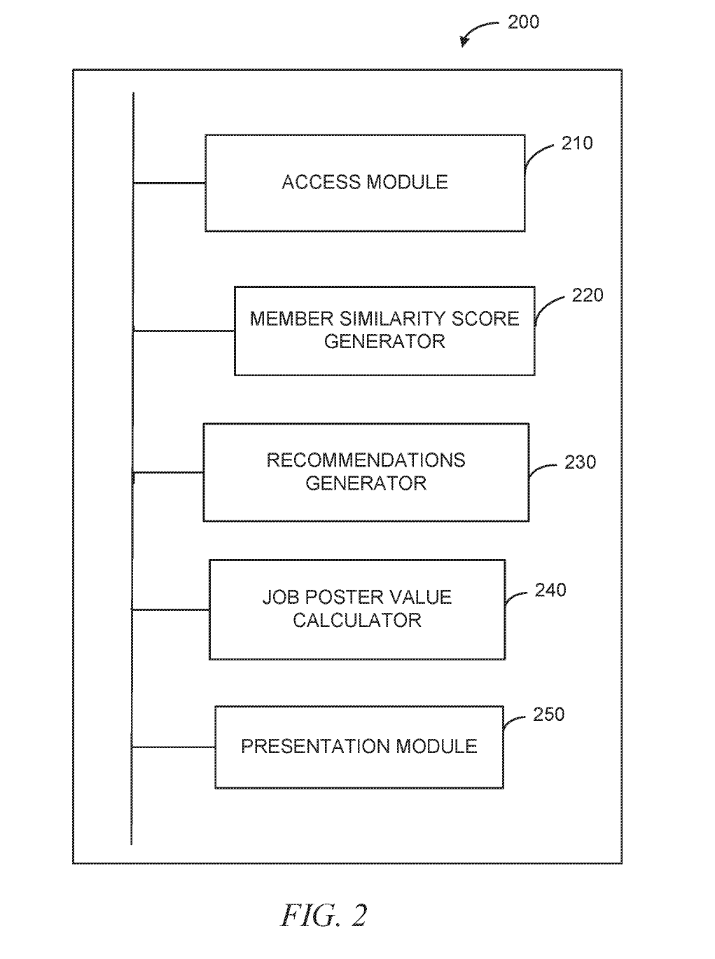

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a recommendation system 144. The recommendation system 144 may be configured to utilize member profile similarity information for selecting one or more job postings for presentation to a member represented by a subject member profile using the methodologies described above. An example of an on-line social network system is LinkedIn®. An example recommendation system, which corresponds to the recommendation system 144 and which is configured to enhance visibility of a job posting in an on-line social network system using member profile similarity information is illustrated in FIG. 2.

FIG. 2 is a block diagram of a system 200 to generate job recommendations in the on-line social network system 142 of FIG. 1 using member profile similarity information. As shown in FIG. 2, the system 200 includes an access module 210, a member similarity score generator 220, a recommendations generator 230, a job poster value calculator 240, and a presentation module 250.

The access module 210 is configured to access a subject member profile representing a member in the on-line social network system 142 of FIG. 1. The member similarity score generator 220 is configured to generate respective similarity scores for pairs comprising a member profile and a job posting. A similarity score generated for a pair comprising a member profile and a job posting reflects similarity between the member profile and a further member profile, for which the job posting has been previously recommended. In one embodiment, the member similarity score generator 220 generates the member similarity score for the pair comprising the subject member profile and the additional job posting by calculating a value that reflects the result of comparison of respective feature vectors representing the subject member profile and the further member profile. In some embodiments, the member similarity score generator 220 generates member similarity scores by applying a graph analysis technique to a member similarity graph. The member similarity graph and some example graph analysis techniques are described above.

The recommendations generator 230 is configured to determine, based on a member similarity score calculated by the member similarity score generator 220 for a pair comprising the subject member profile and the additional job posting, that the additional job posting is to be recommended to the member represented by the subject member profile. In some embodiments, the additional job posting is a job that has been identified as underperforming, based on its job poster value. The system 200 includes, in some embodiments, the job poster value calculator 240 configured to calculate the job poster value for a job posting using, e.g., a value reflecting a number of views with respect to the job posting over a predetermined period of time.

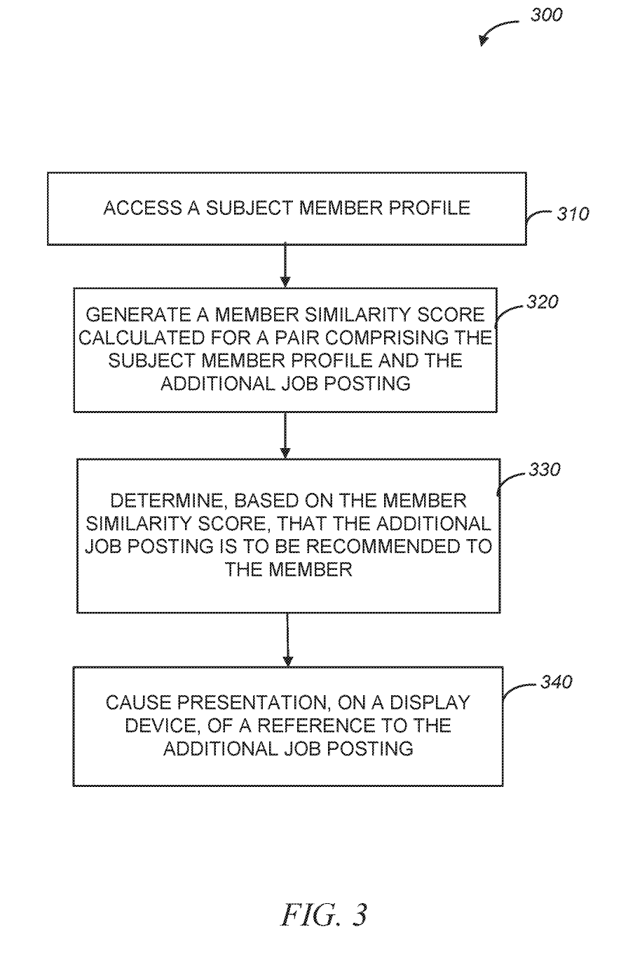

The presentation module 250 is configured to cause presentation, on a display device, of a reference to the additional job posting. In some embodiments, the presentation module 250 includes a reference to the additional underperforming job posting into a set of references to recommended job postings based on availability of a reserved slot in said set. Some operations performed by the system 200 may be described with reference to FIG. 3.

FIG. 3 is a flow chart of a method 300 to generate job recommendations in the on-line social network system 142 of FIG. 1 utilizing member profile similarity values generated for job posting with respect to a subject member profile. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the access module 210 of FIG. 2 accesses a subject member profile representing a member in the on-line social network system 142 of FIG. 1. The member similarity score generator 220 of FIG. 2 generates, at operation 320, a member similarity score for a pair comprising the subject member profile and an additional job posting that has been previously recommended to a member represented by a profile similar to the subject member profile. As mentioned above, similarity of two member profiles may be determined based on a similarity score generated for a job posting with respect to a member profile. At operation 330, the recommendations generator 230 of FIG. 2 determines, based on the similarity score calculated by the member similarity score generator 220, that the additional job posting is to be recommended to the member. At operation 340, the presentation module 250 of FIG. 2 causes presentation, on a display device, of a reference to the additional job posting.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

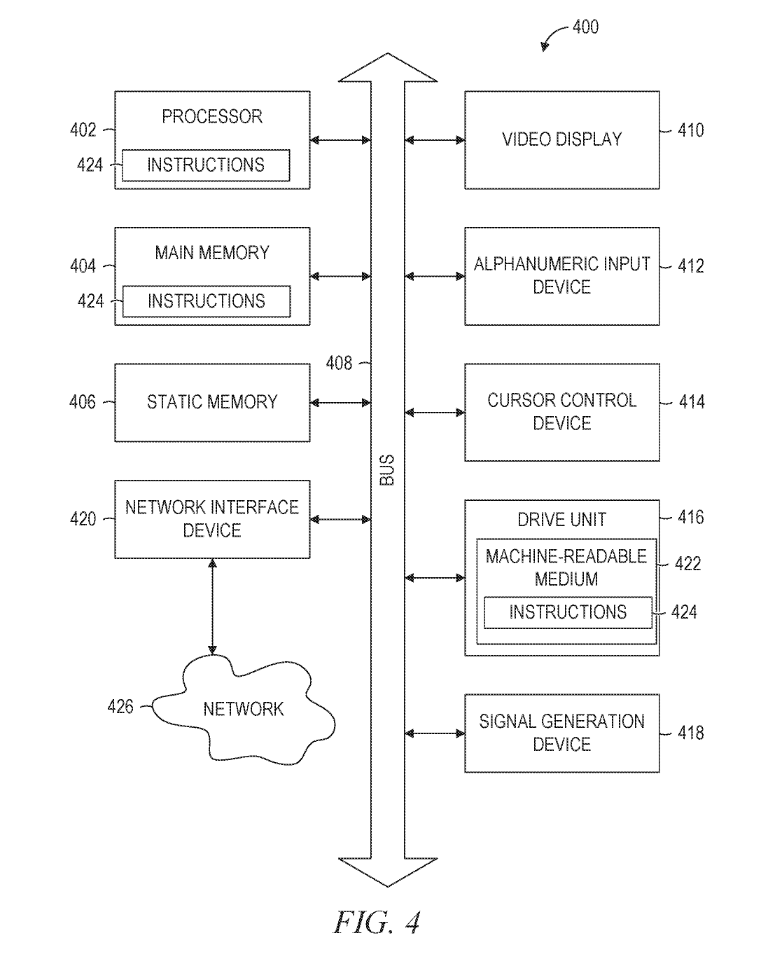

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g. a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g. as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implement module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g. within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g. Application Program Interfaces (APIs).)

Thus, a method and system to generate job recommendations in an on-line social network system using member profile similarity scores has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
accessing a subject member profile representing a member in an on-line social network system;
using at least one processor, determining, based on a member similarity score calculated for a pair comprising the subject member profile and the additional job posting, that the additional job posting is to be recommended to the member, the similarity score reflecting similarity between the subject member profile and a further member profile; and
causing presentation, on a display device, of a reference to the additional job posting.

2. The method of claim 1, wherein the generating of the member similarity score comprises comparing respective feature vectors representing the subject member profile and the further member profile.

3. The method of claim 1, wherein the generating of the member similarity score for the pair comprising the subject member profile and the additional job posting comprises:
accessing a member similarity graph, the member similarity graph is a tripartite graph, a first set of nodes in the member similarity graph comprising nodes representing member profiles in the on-line social network system, a second set of nodes in the member similarity graph comprising nodes representing those member profiles in the on-line social network system that has been identified as similar to at least one member profile represented by a node in the first set of nodes, and a third set of nodes in the member similarity graph comprising nodes representing job postings recommended to at least one member represented by a member profile represented by a node from the second set of nodes, a node from the first set of nodes representing the subject member profile and a node from the third set of nodes representing the additional job posting; and
applying a graph analysis algorithm to the member similarity graph to derive the similarity score for the pair comprising the subject member profile and the additional job posting.

4. The method of claim 3, wherein a weight assigned to an edge associated with a node from the first set of nodes and a node from the second set of nodes is calculated based on similarity of member profiles represented by respective nodes from the first set of nodes and the second set of nodes.

5. The method of claim 3, wherein a weight assigned to an edge associated with a node from the second set of nodes and a node associated with the third set of nodes is calculated based on relevance score calculated for a pair comprising a member profile and a job posting represented by respective nodes from the second set of nodes and the third set of nodes, the relevance score indicating a likelihood that a member represented by the member profile applies for a job represented by the job posting.

6. The method of claim 3, wherein the graph analysis algorithm is a random walk algorithm.

7. The method of claim 1, wherein the additional job posting is selected based on a job poster value calculated for the additional job posting, the job poster value reflecting a level of engagement of members of the on-line social network system with the additional job posting via a graphical user interface provided by the on-line social network system.

8. The method of claim 7, comprising calculating the job poster value using a value reflecting a number of views with respect to the additional job posting over a predetermined period of time.

9. The method of claim 7, wherein the causing of the presentation of the reference to the additional job posting comprises:
including the reference to the additional job posting into a set of references to recommended job postings, based on availability of a reserved slot, a reserved slot in the set of references to recommended job postings designated to reference a job posting having a job poster value less than or equal to an underperformance threshold value.

10. The method of claim 1, wherein the determining of the additional job posting to be recommended to the subject member profile, in addition to being based on the member similarity score, is also based on a relevance value calculated for a pair comprising the subject member profile and the additional job posting, the relevance value is generated based on a member feature vector representing the subject member profile and a job feature vector representing the additional job posting.

11. A computer-implemented system comprising:
an access module, implemented using at least one processor, to access a subject member profile representing a member in an on-line social network system;
a recommendations generator, implemented using at least one processor, to determine, based on a member similarity score calculated for a pair comprising the subject member profile and the additional job posting, that the additional job posting is to be recommended to the member, the similarity score reflecting similarity between the subject member profile and a further member profile; and
a presentation module, implemented using at least one processor, to cause presentation, on a display device, of a reference to the additional job posting.

12. The system of claim 11, wherein the generating of the member similarity score for the pair comprising the subject member profile and the additional job posting comprises comparing respective feature vectors representing the subject member profile and the further member profile.

13. The system of claim 11, comprising a member similarity score generator, implemented using at least one processor, to generate the member similarity score by:
accessing a member similarity graph, the member similarity graph is a tripartite graph, a first set of nodes in the member similarity graph comprising nodes representing member profiles in the on-line social network system, a second set of nodes in the member similarity graph comprising nodes representing those member profiles in the on-line social network system that has been identified as similar to at least one member profile represented by a node in the first set of nodes, and a third set of nodes in the member similarity graph comprising nodes representing job postings recommended to at least one member represented by a member profile represented by a node from the second set of nodes, a node from the first set of nodes representing the subject member profile and a node from the third set of nodes representing the additional job posting; and
applying a graph analysis algorithm to the member similarity graph to derive the similarity score for the pair comprising the subject member profile and the additional job posting.

14. The system of claim 13, wherein a weight assigned to an edge associated with a node from the first set of nodes and a node from the second set of nodes is calculated based on similarity of member profiles represented by respective nodes from the first set of nodes and the second set of nodes.

15. The system of claim 13, wherein a weight assigned to an edge associated with a node from the second set of nodes and a node associated with the third set of nodes is calculated based on relevance score calculated for a pair comprising a member profile and a job posting represented by respective nodes from the second set of nodes and the third set of nodes, the relevance score indicating a likelihood that a member represented by the member profile applies for a job represented by the job posting.

16. The system of claim 13, wherein the graph analysis algorithm is a random walk algorithm.

17. The system of claim 11, wherein the recommendation module is to select the additional job posting based on a job poster value calculated for the additional job posting, the job poster value reflecting a level of engagement of members of the on-line social network system with the additional job posting via a graphical user interface provided by the on-line social network system.

18. The system of claim 17, comprising a job poster value calculator, implemented using at least one processor, to calculate the job poster value using a value reflecting a number of views with respect to the additional job posting over a predetermined period of time.

19. The system of claim 17, wherein the presentation module is to include the reference to the additional job posting into a set of references to recommended job postings, based on availability of a reserved slot, a reserved slot in the set of references to recommended job postings designated to reference a job posting having a job poster value less than or equal to an underperformance threshold value.

20. A machine-readable non-transitory storage medium having instruction data executable by a machine to cause the machine to perform operations comprising:
accessing a subject member profile representing a member in an on-line social network system;
determining, based on a member similarity score calculated for a pair comprising the subject member profile and the additional job posting, that the additional job posting is to be recommended to the member, the similarity score reflecting similarity between the subject member profile and a further member profile; and
causing presentation, on a display device, of a reference to the additional job posting.
